(19) United States
(12) Patent Application Publication
(10) Pub. No.: US 2004/0164210 A1
(43) Pub. Date: Aug. 26, 2004

(54) Vehicle mounting system for a video display unit

(76) Inventors: Thai Le, Pontiac (CA); Ali Mortazavi, Kanata (CA)

Correspondence Address: Cassan Maclean, Suite 401, 80 Aberdeen Street, Ottawa, ON, K1S 5R5, CA

(21) Appl. No.: 10/368,571

(22) Filed: Feb. 20, 2003

(51) Int. Cl. F16M 11/00

(52) U.S. Cl. 248/200

(57) ABSTRACT

Systems and devices relating to the mounting of video display units (VDUs) in vehicles. A mounting system includes a mounting plate that is attached to the floor of the rear passenger area of the vehicle. A hollow shaft is attached to the mounting plate and is vertically positioned relative to the floor. At the top of the shaft, a VDU enclosure is mounted by inserting a portion of the enclosure in the shaft. The enclosure is rigid and has a transparent viewing panel which corresponds to the screen of the terminal contained in the enclosure. The enclosure may be rotated about the shaft and the shaft can pivot abut the plate. This allows the VDU to be positioned to the optimal position for viewing by any of the rear passengers. Also, the VDU may be moved away from either the rear of the front passengers as the need arises. In case of a vehicular accident, the pivotable nature of the shaft allows the terminal unit to not be a safety hazard.

### FIELD OF THE INVENTION

The present invention relates to display units, interactive/smart terminals and is especially applicable but not limited to means for mounting such devices inside vehicles.

### BACKGROUND TO THE INVENTION

The ever decreasing size of televisions have made their deployment in vehicles a matter of inevitability. Nowadays, video display units (VDUs) are ubiquitous—they can be found in all manners of vehicles. Previously, vehicle mounted VDUs were the exclusive area of luxury cars and limousines. Today, VDUs can be found mounted in the passenger seats of aircraft, in the cabins of vans and mini-vans, and even in taxi-cabs.

This widespread adoption of VDU technology in vehicles has given rise to a latent problem—the placement and mounting of the VDU. Currently, VDUs can be mounted from the roof of vehicles. These drop-down configurations are usually found in vans and mini-vans that are equipped with ample head room. While such a configuration provides good security for the VDU, they may affect the resale value of the vehicle as their mounting requires that holes be made in the ceiling liner. Furthermore, uniformity between installations cannot be achieved since the VDU has to be installed in the vehicle's rib line for structural support. Since the rib line is in a different place for different vehicle models, there is no guarantee that one installation location in one vehicle model will work for another vehicle model. Also, this configuration cannot be adapted for regular automobiles that, generally, have less head room than vans or mini-vans. If drop down VDUs were installed in automobiles, they will not only obstruct the driver's rear view, and thereby become a potential hazard, but they are also inconvenient for the rear passengers who are supposed to be using them. Even though roof mounted VDUs provide good viewing characteristics (since there is very little there is very little glare from sunlight), they are fairly inconvenient to view for the rear passengers of automobiles. These passengers generally have to tilt and crane their necks at unusual angles to be able to watch the VDU. In terms of safety, roof mounted VDUs may be problematic in collisions. Tall passengers in the rear passenger compartment may hit their head on the VDU in a collision. Finally, due to the destructive modifications required to install the VDU in the drop-down configuration, the resale value of the vehicle can be adversely affected by such a VDU installation.

Another possible configuration is that of mounting the VDU in or behind the headrests of one of the front seats. While similar in function and configuration to the personal entertainment units found in some passenger aircraft, this configuration also has significant drawbacks. One main drawback is the inconvenient viewing angle that one of the rear passengers has to endure. The rear passenger sitting directly behind the VDU-equipped front seat has a good view but the other rear passenger does not have a good view. This other passenger needs to stretch and crane his or her neck to obtain even a glimpse of the VDU. While mounting a VDU in each of the head rests solves this viewing problem, this also doubles the cost.

A third option is to mount or hang a VDU behind one of the front seats but not in the headrest. Again, this option suffers from the drawbacks that only one rear passenger can clearly view the VDU. A further option, that of installing the VDU inside one of the front seats and facing the rear passengers, suffers from the same drawbacks noted above.

Another issue plaguing the vehicle mounted VDU is the threat of theft and vandalism. If the VDU is mounted in a taxicab, the VDU should be protected from the unpredictable and sometimes destructive behaviour of rear passengers. Furthermore, vehicle mounted VDUs can serve as focal points for potential thieves when the vehicle is left unattended or is parked in a vulnerable area. Ideally, the vehicle mounted VDU is easily removable or concealable to remove the temptation from would be vandals and thieves.

A further issue that may affect VDUs and their mountings is passenger safety. Ideally, vehicle mounted VDUs should not present a safety hazard in the event of a vehicular accident. The above described mounting techniques may present safety issues since, in the event of a vehicular accident, the VDUs may be dislodged and collide with the rear passengers.

All of the installations listed above have one drawback in common: all of these mounting methods are, essentially, custom mounts, custom designed and custom fitted for their specific vehicles. Currently, there does not seem to be any mounts which can be used for a majority of vehicles that does not require extensive destructive modifications that adversely affects a vehicle's resale value, is safe for passengers, and provides good viewing angles for the rear passengers.

It is therefore an object of the present invention to mitigate if not overcome the issues and drawbacks of the prior art. There is therefore a need for a mounting technique that can mount a VDU in a vehicle and provide adequate viewing coverage to the VDU for most if not all of the rear passengers. Such a mounting technique should also avoid the safety issues noted above.

### SUMMARY OF THE INVENTION

The present invention provides systems and devices relating to the mounting of video display units (VDUs) in vehicles. A mounting system includes a mounting plate that is attached to the floor in a passenger viewing area and underneath one of the front seats of the vehicle. A hollow shaft is attached to the mounting plate and is vertically positioned relative to the floor. At the top of the shaft, a VDU enclosure is mounted by inserting a portion of the enclosure in the shaft. The enclosure is rigid and has a transparent viewing panel which corresponds to the screen of the VDU contained in the enclosure. The enclosure may be rotated about the shaft and the shaft can pivot about the plate. This allows the VDU to be positioned to the optimal position for viewing by any of the rear passengers. Also, the VDU may be moved away from either the rear or the front passengers as the need arises. In case of a vehicular accident, the pivotable nature of the shaft allows the VDU unit to not be a safety hazard.

In a first aspect, the present invention provides a plate for use in mounting a terminal in a vehicle, the plate comprising:

a mounting portion attachable to a floor of said vehicle by an attachment means;

a coupling portion attachable to mounting means for mounting said terminal, said coupling portion being attached to said mounting portion.

In a second aspect the present invention provides a system for mounting a terminal in a vehicle, the system comprising:

a plate attachable to a floor of said vehicle;

a shaft means attachable to said plate;

a terminal enclosure mountable on said shaft means for holding said terminal,

wherein

said terminal is in a substantially upright position relative to said floor when said shaft means is attached to said plate and when said terminal enclosure is mounted on said shaft means.

In a third aspect the present invention provides a terminal enclosure for use in mounting a terminal on a shaft, the enclosure comprising:

a rigid shell enclosing said terminal, said shell having a transparent section corresponding to a viewing area of said terminal;

a rigid top removably attachable to said shell;

rigid bottom removably attachable to said shell, said bottom having securing means for securing said terminal to said bottom; and

mounting means attached to said enclosure for mounting said enclosure on said shaft.

### BRIEF DESCRIPTION OF THE DRAWINGS

A better understanding of the invention will be obtained by considering the detailed description below, with reference to the following drawings in which:

FIG. 1 is a perspective view of a terminal mounting system according to the invention;

FIG. 1A is an exploded view of the terminal mounting system of FIG. 1.

FIG. 2 is an exploded view of the mounting plate and shaft of the system of FIG. 1;

FIG. 3 is a perspective view of the mounting plate of FIGS. 1 and 2;

FIG. 3A is a front end view of the mounting plate and shaft of FIG. 2 illustrating the deployment of the mounting plate on a vehicle with a transmission hump;

FIG. 4 is a perspective view of the enclosure used in FIG. 1;

FIG. 5 is an exploded view of the enclosure in FIG. 4 illustrating the different parts of the enclosure;

FIG. 6 is a perspective view of a cradle used in the enclosure of FIGS. 4 and 5;

FIG. 7 is a perspective view of a mounting bar for use in mounting the enclosure of FIG. 4 on to the shaft of FIG. 2; and

FIG. 7A is a perspective view of a coupling bar for use in mounting the mounting bar of FIG. 7 on the mounting plate of FIG. 3; and

FIG. 8 is a perspective view of an alternative mounting plate for use on vehicles not equipped with a transmission hump.

### DETAILED DESCRIPTION

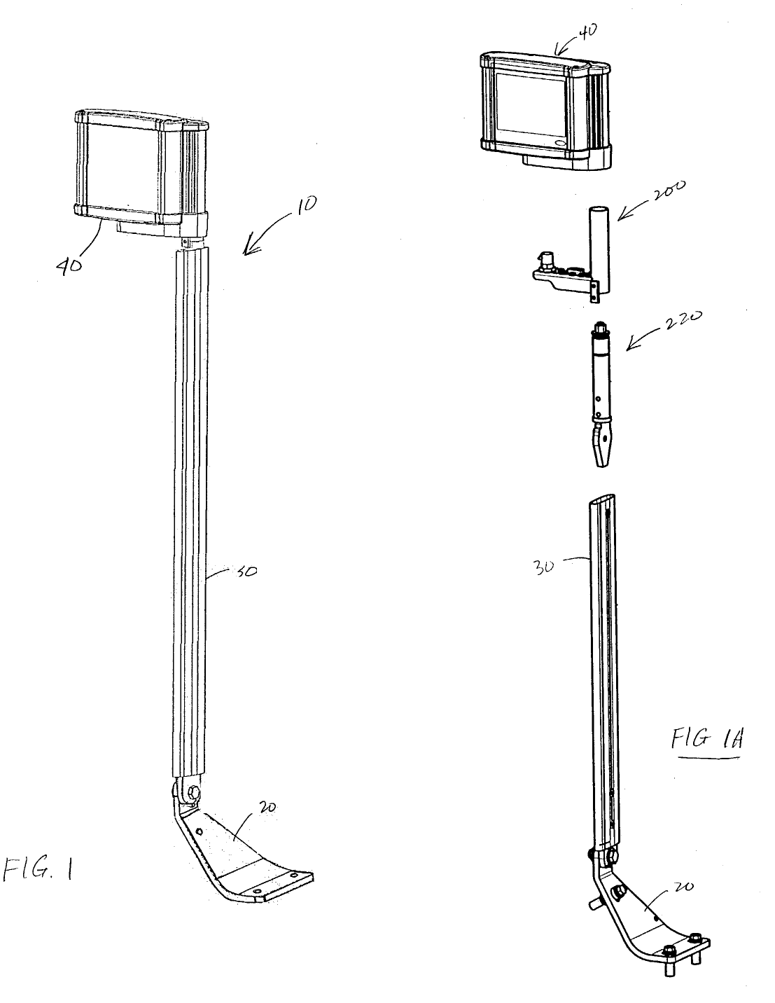

Referring to FIG. 1, a mounting system 10 for a video display unit in a vehicle is illustrated. The system 10 has a mounting plate 20, a shaft 30, and a terminal enclosure 40. The mounting plate 20 is attached to the floor of a vehicle, preferably to the floor of a passenger area, and the shaft 30 is attached to the mounting plate 20 such that the shaft is substantially upright relative to the vehicle floor. The terminal enclosure 40 is mounted atop the top end of the shaft 30.

Referring to FIG. 1A, an exploded view of the mounting system 10 is illustrated. As can be seen, the terminal enclosure 40 attaches to a cradle 200. The cradle 200 couples to a mounting bar 220 and the mounting bar 220 inserts into the shaft 30. Details regarding these different parts are outlined below.

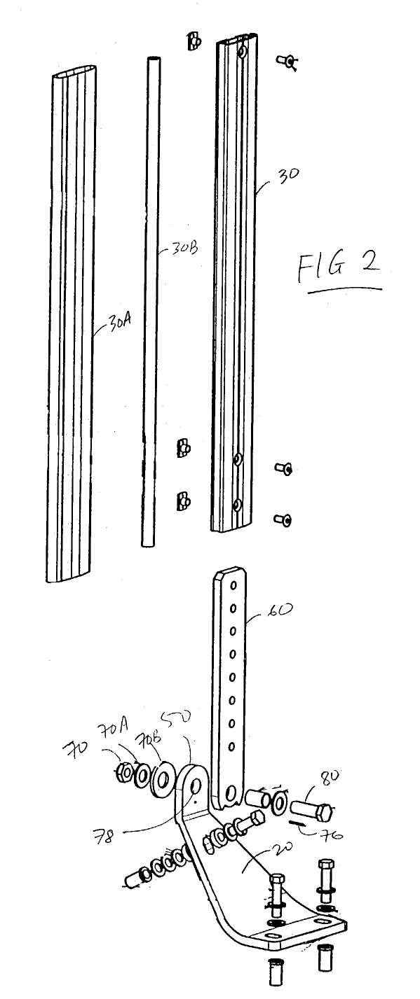

Referring to FIG. 2, an exploded view of the shaft 30 and of the mounting plate 20 is illustrated. The plate 20 has a coupling portion 50 on which a coupling bar 60 is attached by a nut 70 and bolt 80 arrangement. The coupling bar 60 can then be inserted into one end of the shaft 30. Washers 70A, 70B are also used to provide sufficient friction to prevent the coupling bar 60 from being too tightly bolted to the coupling portion 50.

It should be noted that, preferably, the shaft 30 is hollow to accommodate the coupling bar 60. While the inner cross-sectional shape of the hollow shaft 30 is not critical, it must match the outer cross-sectional shape of the coupling bar 60. Furthermore, while the above discussion recounts inserting the coupling bar 60 into the shaft 30, the converse could also be done with some design changes. Thus, by having a hollow coupling bar 60 and a solid shaft 30, both of which have cross-sectional areas which mate, the shaft 30 may be inserted into the bar 60.

It should further be noted that the shaft 30 is, preferably, covered by a protective covering 30A. Such a protective covering would protect the passengers in case there is any hard contact or collision between a passenger and the shaft 30. As such, a rubber coated covering or foam such as polyethylene foam or EVA (Ethylene Vinyl Acetate) foam may be used. Ideally, such a covering would be closely conformed to the shape of the shaft 30. In one embodiment, Tygon™ plastic tubing is heat shrunk around the shaft as protective covering 30A may also be provided with a channel 30B that accommodates the cables and wires that feed into the terminal enclosure 40 for the terminal 170. Alternatively, the shaft 30 may be manufactured such that it is equipped with a channel for the cables and wires. For this configuration, the channel 30B in FIG. 2 may therefore be a hollow rubber tube provided as a cushion in case the passenger collides with the mounting system. The protective covering 30A can therefore be shrunk around both the shaft 30 and the channel 30B with the wires and cables being passed through either the channel 30B or through a channel integral to the shaft 30.

It has been found that the use of a lightweight material such as aluminum is ideal for the shaft. The coupling bar 60 may also be of equally strong material. For an aluminum implementation of the shaft 30, a rectangular cross-section provides structural strength to the shaft 30.

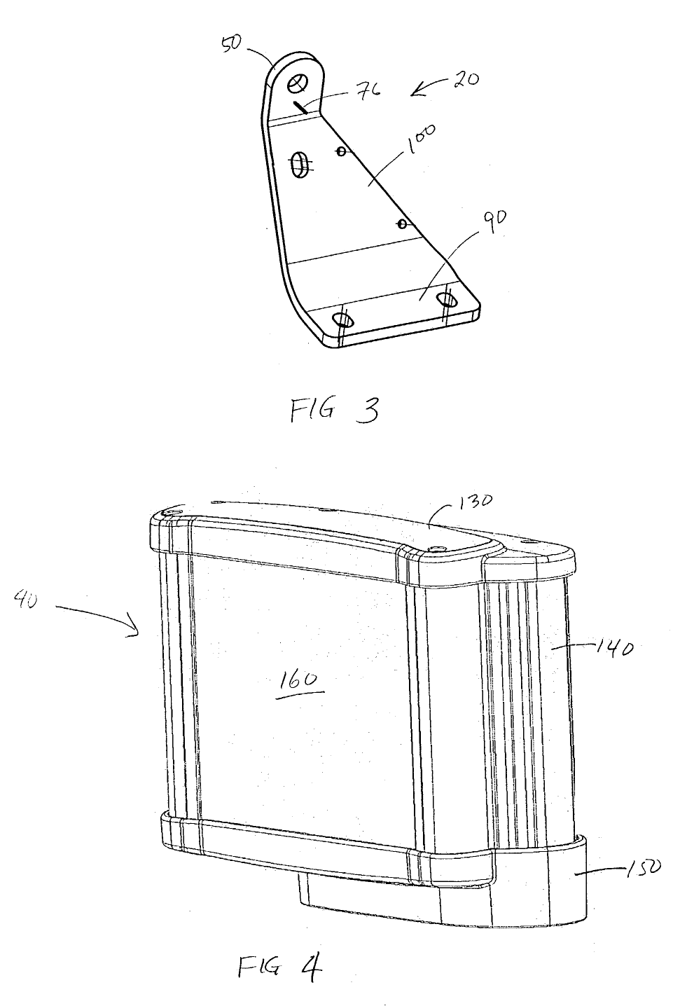

Referring to FIG. 3, a perspective view of the mounting plate 20 is illustrated. The mounting plate 20 has 3 portions—a mounting portion 90, a connecting portion 100, and a coupling portion 50. The mounting portion 90 is attachable to a vehicle floor by attachment means such as bolts rivet nuts and/or screws. Ideally, rivet nuts are used for attaching the mounting portion 90 to the vehicle floor as rivet nuts not only attach the mounting portion 90 but they also seal the hole through which they are inserted. The coupling portion 50, as noted above, can be attached to the shaft 30 by way of a coupling bar 60 and a nut and bolt. The connecting portion 100 connects the mounting portion 90 and the coupling portion 50. As can be seen in the illustration, the mounting portion 90 is in a substantially horizontal orientation relative to the vertical orientation of the coupling portion 50. The connecting portion 100 is in an angled relationship to both the mounting portion 90 and the coupling portion 50. It has been found that the ideal mounting configuration of the mounting plate 20 is to mount it to the floor underneath one of the supports for a front seat. This provides greater strength and stability to the mounting. Mounted as such, the shaft 30 is positioned between the two front seats and the terminal enclosure is also positioned between the front seats.

The angle relationship allows the system 10 to be deployed in the passenger area of automobiles that have a so-called “transmission hump”. This transmission hump, present in vehicles that have a transmission axle running from the front to the rear, is usually found between the foot wells of the rear passengers areas. Referring to FIG. 3A, an end view of the system 10 deployed in such a vehicle is illustrated. As can be seen, the transmission hump 110 lies behind the connecting portion 100 while the mounting portion 90 is attached to the vehicle floor 120. The angled relationships between the three portions of the mounting plate 20 can also be clearly seen in FIG. 3A. For differently sized transmission humps, the positioning of the mounting plate can be adjusted by inserting properly sized washers between the connecting portion 100 and the transmission hump 110. Also, to better secure the mounting plate 20, the connecting portion 100 can be attached to the transmission hump by means of screws, bolts, washers, rivet nuts, or any suitable attachment means (as shown in FIG. 2).

Regarding the construction of the mounting plate 20, as can be seen from FIG. 3, it is preferably of a unitary construction. Preferably, the mounting plate 20 is of rigid metal construction with appropriate holes to accommodate the relevant screws or bolts required to attach the plate to any of the vehicle floor, the transmission hump, or the shaft 30.

Referring to FIG. 4, a perspective view of the terminal enclosure 40 is illustrated. The enclosure 40 has three main parts: a top 130, a shell 140, and a bottom 150. These parts all attach to provide a rigid enclosure for the terminal 170 which is housed inside. The enclosure 40 also has a transparent area 160 which corresponds to the viewing area of the terminal housed inside.

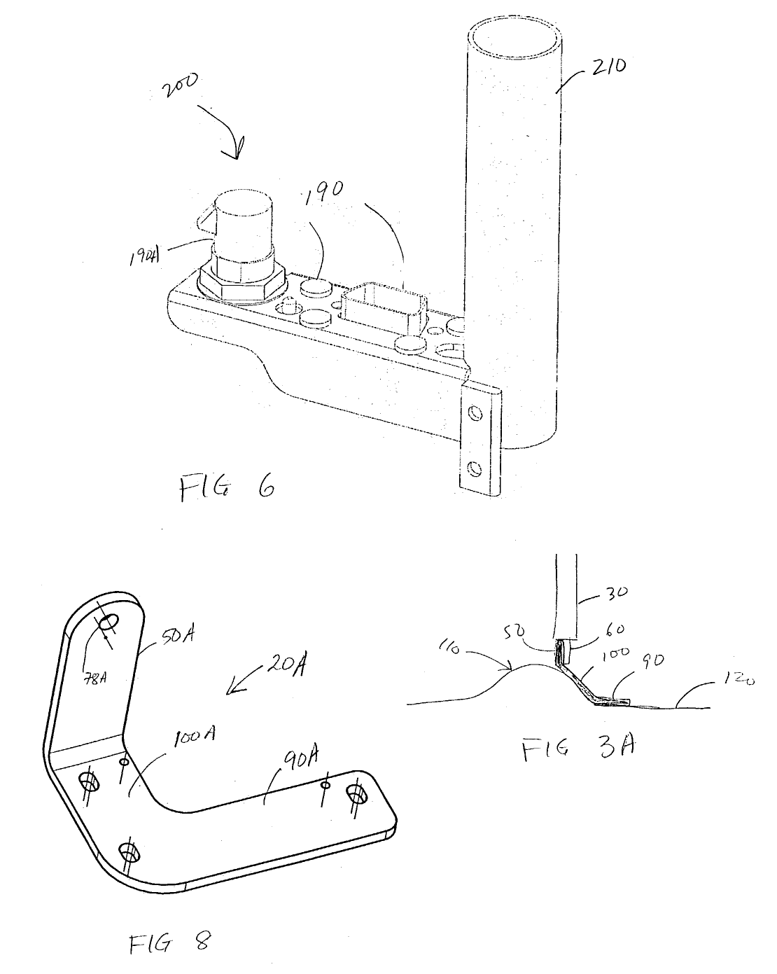

Referring to FIG. 5, an exploded view of the enclosure 40 is illustrated. As can be seen, the three parts of the enclosure mate together to form the enclosure 40 as illustrated in FIG. 4. The top 130 is preferably of rigid construction such as hard ABS (Acrylonitrile Butadiene Styrene) plastic or PE (polyethylene) may be used. To avoid some environmental concerns with temperature, it has been found that polyethylene plastic is preferable. The top 130 is secured to the shell 140 by means of screws or bolts 180. The terminal 170 sits inside the shell 140 and the terminal's viewing area 175 corresponds to the transparent area 160 of the shell 140. The shell 140 can, again, be constructed out of hard plastic while the transparent area can be a sheet of Plexiglass™ or any other type of transparent sheet of plastic (such as Lexan™) that is impact and, preferably, scratch resistant. The shell 140 encircles and encloses the terminal 170 on all of the terminal's sides except for its top and bottom. The use of hard plastic and of scratch and impact resistant materials for the enclosure will ensure that the terminal is safe from the unpredictable actions of rear passengers. The optional use of an anti-glare covering or material for the transparent area 160 can vitiate the effects of sunlight and/or headlights on the passenger's viewing experience.

The bottom 150 of the enclosure 140 is, again, constructed from a hard plastic and is provided with connection points 190 (in a cradle 200) that not only holds the terminal 170 in place but also provide the electrical/data coupling points for the terminal 170. These connection points 190 are adjacent a hole (not shown) in the bottom 150. Extra holes in the bottom can be provided to direct sound coming from the terminal downward. These downward facing holes are advantageous as they allow sound to escape from the enclosure 40 but, because they are directed downward, they are not readily accessible to mischief minded rear passengers

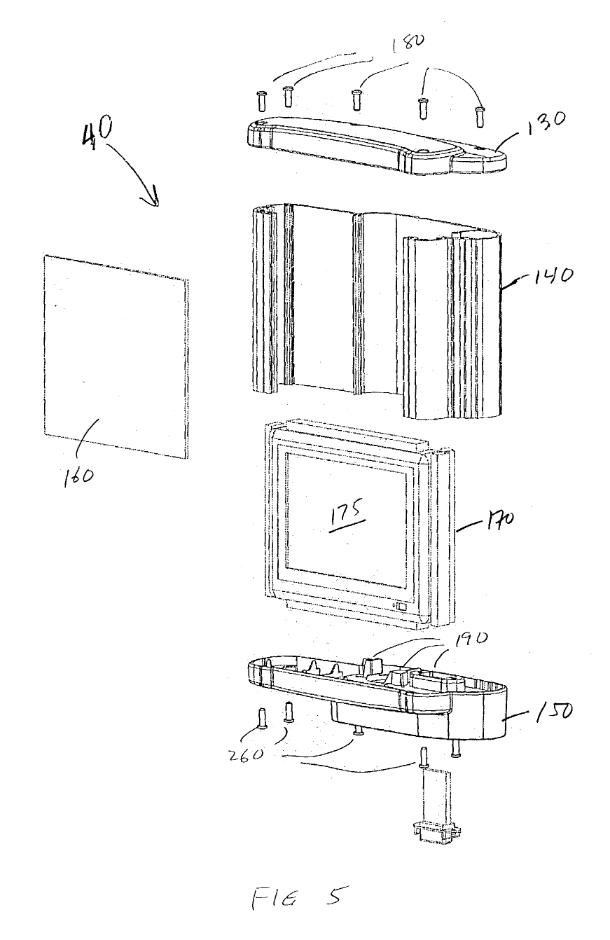

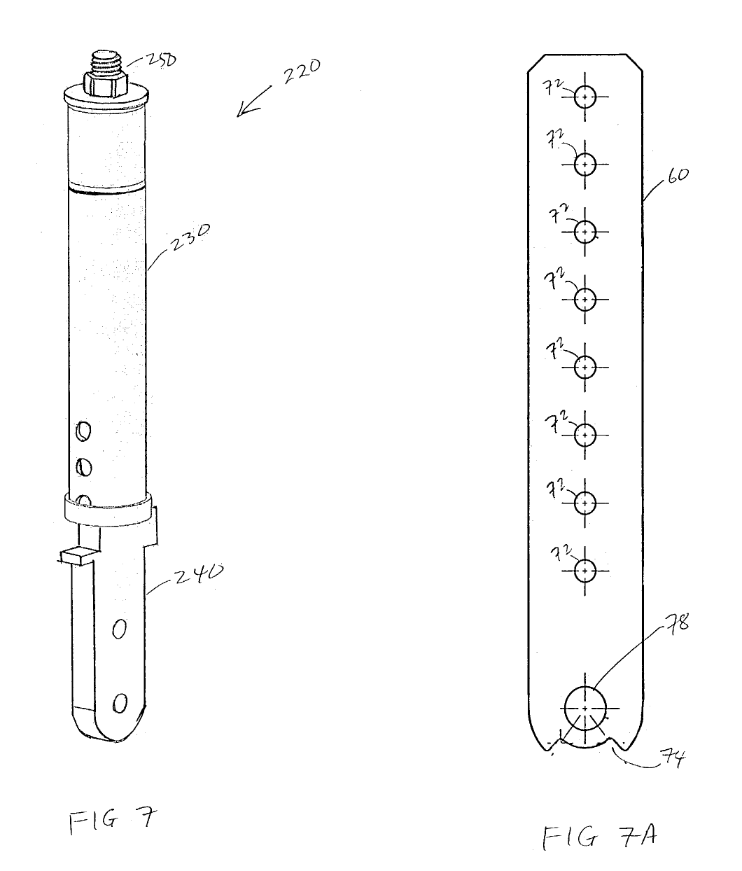

Mating with the bottom 150, a cradle 200 is shown in FIG. 6. The cradle 200 has the connection points 190 including a Centronics connector that provides the electronic connection to the terminal 170. As noted above, the cradle 200 mates with the bottom 150 and is adjacent the hole in the bottom. This hole is provided to accommodate a tube 210 that is connected to the cradle 200. The tube 210 acts as a sleeve to a mounting bar 220. This mounting bar 220 is illustrated in FIG. 7. A locking mechanism 190A is also provided so that the terminal may be locked into place within the enclosure 140.

Referring to FIG. 7, the mounting bar 220 has an upper portion 230 and a lower portion 240. The upper portion 230 has a cross-sectional shape that mates with the cross-sectional shape and size of the tube 210 so that the enclosure 40 can rotate about the shaft 30. This rotatability is due to the fact that the lower portion 240 of the mounting bar 220 can be mounted on to the hollow shaft 40. In this embodiment, this is done by inserting the lower portion 240 into a top end of the shaft 40. The top most end of the upper portion 230 is provided with a threaded end 250 that screws into the top 130 of the enclosure. The bottom 150 of the enclosure 40 is attached to the shell 140 by way of screws or bolts 260.

To prevent unfettered rotatability of the enclosure 40 about the shaft 30 the inside of the tube 210 or the outside of the upper portion 230 may be provided with frictional covering (such as rubber) to allow for frictional resistance. This frictional resistance should prevent unfettered rotatability of the enclosure but should still allow the enclosure to be rotated and positioned at desired angles. The frictional covering also provides cushioning for the enclosure 40 against vibrations.

The different parts of the enclosure 40 should be held together by screws or bolts that are not easily removable once they are installed. This way, the owner can install the terminal in the enclosure 40 and passengers do not have direct access to the terminal. The passengers can view the viewing area of the terminal through the transparent area 160 without having the access or opportunity to possibly damage the terminal.

As noted above, the shaft 30 may pivot about the coupling portion 50 of the plate 20. Thus, from FIG. 1, the shaft 30 may move in a direction perpendicular to the plane of the viewing area of the terminal 170. This is accomplished by the use of the nut and bolt arrangement which attaches the coupling bar 60 to the plate 20. The coupling bar may be securely attached to allow for some “play” or movement in the shaft 30. This may be accomplished by using washers with the nut 70 and bolt 80 arrangement. This will allow the shaft 30 to give way in case the rear passenger collides with the shaft 30 in a vehicular accident. For the same eventuality, the protective covering 30A is provided for the shaft 30.

Referring to FIG. 7A, an illustration of the coupling bar 60 is provided. As can be seen, multiple holes 72 are provided. This allows for mounting the shaft 30 at different heights. As can also be seen, a passage 74 is also provided. This passage accommodates a pin 76 (see FIG. 2) that is placed below a hole 78 in the coupling portion 50. The pin 76 allows the bar 60 to pivot about the hole 78. The sides of the passages 74, in conjunction with the pin 76, allow the bar 60 a limited pivotability or range.

It should also be noted that the enclosure 40 may be removable from its mounted position on the shaft 30 by the removal of screws that hold the lower portion 240 from its inserted position in the shaft 30. This allows the enclosure 40, with the terminal inside, to be removed from its mounting for safekeeping. Thus, vehicle owners can remove the terminal from the vehicle prior to leaving the vehicle unattended for long periods of time.

As an alternative to the removal of screws to remove the enclosure 40, an automatically latching lock system, similar to that used for laptop docking stations, may be used. The locking mechanism 190A (see FIG. 6) which locks the enclosure 40 into place may be provided with a quick release mechanism activatable by a key provided to the vehicle owner. Thus, owners can use the key to easily remove/unlock the enclosure 40 without using inconvenient screws. Owners can therefore unlock the enclosure 40 and remove it from the mounting system 10 without uninstalling the mounting bar 220 or the cradle 200. To reinstall the enclosure 40, the owner merely has to align the bottom 150 with the cradle 200 and the hole with the tube 210. Then, the owner slides the enclosure 40 into place as the locking mechanism 190A locks the enclosure into place. The use of a Centronics connector (or any similar connector) simplifies this operation as alignment and attachment of the various electrical connection points are easily accomplished by the Centronics connector.

In terms of placement, it has been found that deploying the system 10 in the rear passenger area but between the two front seats was optimal. Both rear passengers can be given a useful view of the terminal while the safety risks are minimized. In case of a vehicular accident, neither of the two rear passengers is directly behind the terminal and the safety features outlined above minimize any injury should there be a collision between a passenger and the terminal mounting system. The placement of the system 10 is ideally between the two front seats and behind the passenger front seat so that the rear passenger's leg room is unobstructed. For vehicles without the transmission hump, the rear passenger's leg room is not obstructed since no portion of the mounting plate is in the rear passenger footwell area.

Referring to FIG. 8, a second embodiment of a mounting plate 20A is illustrated. This mounting plate 20A is to be deployed in vehicles that do not have a transmission hump. As can be seen, it also has a mounting portion 90A, a connecting potion 10A, and a coupling portion 50A. The mounting portion 90A mounts on to the floor of the vehicle, preferably under one of the front seats, and the coupling portion 50A serves the same function as the coupling portion 50 of the mounting plate 20 illustrated in FIG. 3.

It should be noted that even though the above description refers to a terminal such as a VDU, other types of terminals may be mounted using the above described invention. Smart terminals, interactive terminals, computer terminals, and any other device which facilitates passenger viewing of video and/or multimedia content may be used in lieu of the VDU.

A person understanding this invention may now conceive of alternative structures and embodiments or variations of the above all of which are intended to fall within the scope of the invention as defined in the claims that follow.

What is claimed is:

1. A plate for use in mounting a terminal in a vehicle, the plate comprising:
a mounting portion attachable to a floor of said vehicle by an attachment means;
a coupling portion attachable to mounting means for mounting said terminal, said coupling portion being attached to said mounting portion.

2. A plate according to claim 1 wherein said mounting means is a shaft means on which said terminal is mounted.

3. A plate according to claim 2 further including a connecting portion connecting said mounting portion with said coupling portion.

4. A plate according to claim 3 wherein said mounting portion and said connecting portion are in an angled relationship to one another.

5. A plate according to claim 3 wherein said coupling portion and said connecting portion are in an angled relationship to one another.

6. A plate according to claim 5 wherein said connecting portion is attachable to a transmission hump in a rear passenger area of said vehicle.

7. A plate according to claim 3 wherein said attachment means are rivet nuts and said mounting portion has holes to accommodate said rivet nuts.

8. A plate according to claim 6 wherein said connecting portion is attachable to said transmission hump by at least one screw and said connecting portion has at least one hole to accommodate said at least one screw.

9. A system for mounting a terminal in a vehicle, the system comprising:
a plate attachable to a floor of said vehicle;
a shaft means attachable to said plate;
a terminal enclosure mountable on said shaft means for holding said terminal,
wherein
said terminal is in a substantially upright position relative to said floor when said shaft means is attached to said plate and when said terminal enclosure is mounted on said shaft means.

10. A system according to claim 9 wherein said plate comprises:
a mounting portion attachable to said floor of said vehicle by an attachment means;
a coupling portion attachable to said shaft means; and
a connecting portion connecting said mounting portion with said coupling portion.

11. A system according to claim 9 wherein said mounting portion and said connecting portion are in an angled relationship to one another.

12. A system according to claim 9 wherein said coupling portion and said connecting portion are in an angled relationship to one another.

13. A system according to claim 9 wherein said connecting portion is attachable to a transmission hump in a rear passenger area of said vehicle.

14. A system according to claim 9 wherein said shaft means comprises a hollow shaft.

15. A system according to claim 9 wherein said shaft means is covered by a protective covering.

16. A system according to claim 9 wherein said shaft means is provided with a channel for cables for said terminal.

17. A system according to claim 15 wherein said protective covering is selected from a group comprising:
Polyethylene foam;
Ethylene Vinyl Acetate (EVA) foam; and
heat shrunk covering.

18. A system according to claim 9 wherein said shaft means is pivotably attachable to said plate.

19. A system according to claim 9 wherein said terminal enclosure is pivotably mountable on said shaft means.

20. A system according to claim 14 wherein said metal shaft is attachable to said plate by a coupling bar attached to said plate, said coupling bar being capable of being inserted into said hollow shaft at a first end of said shaft.

21. A system according to claim 14 wherein said terminal enclosure is mountable on said shaft using a mounting bar attached to said enclosure, said mounting bar being capable of being inserted into said hollow shaft at a second end of said shaft.

22. A terminal enclosure for use in mounting a terminal on a shaft, the enclosure comprising:
a rigid shell enclosing said terminal, said shell having a transparent section corresponding to a viewing area of said terminal;
a rigid top removably attachable to said shell;
rigid bottom removably attachable to said shell, said bottom having securing means for securing said terminal to said bottom; and
mounting means attached to said enclosure for mounting said enclosure on said shaft.

23. An enclosure according to claim 22 wherein said mounting means is removably insertable to an end of said shaft.

24. An enclosure according to claim 22 wherein said mounting means is a mounting bar which is inserted in one end of said shaft.

25. An enclosure according to claim 22 wherein said mounting means is rotatably attached to said enclosure such that said enclosure can rotate about said mounting means.

26. An enclosure according to claim 25 wherein said mounting means includes a tubular section with a circular cross-section and said enclosure includes an attachment section which mounts as a sleeve to said tubular section of said mounting means.

27. A system according to claim 9 wherein said enclosure comprises:
a rigid shell enclosing said terminal, said shell having a transparent section corresponding to a viewing area of said terminal;
a rigid top removably attachable to said shell;
rigid bottom removably attachable to said shell, said bottom having securing means for securing said terminal to said bottom; and
mounting means attached to said enclosure for mounting said enclosure on said shaft.

28. A plate according to claim 3 wherein said mounting portion is attachable between said floor and a front seat of said vehicle.

29. A system according to claim 9 wherein said enclosure is easily removable from said shaft means.

30. A system according to claim 29 wherein said enclosure locks into place once said enclosure is aligned and mated with a cradle.

31. A system according to claim 19 wherein said shaft means is provided with a frictional covering.

32. A system according to claim 18 wherein said shaft means is pivotably attachable to said plate such that said shaft means gives way when a passenger collides with said shaft means.

33. A system according to claim 18 wherein a range of pivotability of said shaft means is controlled by a pin located in said plate and a passage in which said pin is accommodated.

34. A system according to claim 9 wherein said terminal enclosure is provided with downward facing holes for allowing sound to escape from said enclosure.

35. A terminal enclosure according to claim 22 wherein said rigid bottom is provided with downward facing holes for allowing sound to escape from said enclosure.
